(19) United States
(12) Patent Application Publication
(10) Pub. No.: US 2025/0338006 A1
(43) Pub. Date: Oct. 30, 2025

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Kimihiro MASUYAMA, Tokyo (JP)

(21) Appl. No.: 19/180,228

(22) Filed: Apr. 16, 2025

(30) Foreign Application Priority Data
Apr. 24, 2024 (JP) 2024-070809

(51) Int. Cl. H04N 23/62; H04N 23/73; H04N 23/86

(52) U.S. Cl. CPC H04N 23/62; H04N 23/73; H04N 23/86

(57) ABSTRACT

An information processing apparatus comprises an obtaining unit configured to obtain a recommended image-capturing parameter, based on content of image processing performed on image-capturing information obtained through image capturing, and a registration unit configured to register the image-capturing information and the recommended image-capturing parameter in association with each other as learning data.

### BACKGROUND OF THE INVENTION

### Field of the Invention

The present invention relates to an information processing technique.

### Description of the Related Art

In recent years, a raw value, which is called RAW, of a sensor has been able to be recorded as captured data not only with a digital camera, but also with a smartphone. A RAW image has a larger bit depth and a higher degree of freedom in image editing than an image with JPEG, which is a commonly used image format. Therefore, image editing with RAW is essential for correcting an image captured with faulty camera settings, and seeking for a captured image with higher quality.

Japanese Patent Laid-Open No. 2003-187215 proposes a method including compiling feature amounts of images and correction processing into a database, performing feature amount extraction on a new image, and determining a suitable correction processing parameter from the database.

However, image correction is processing for correcting an already captured image through digital numerical value calculation, and therefore is problematic in that the larger the correction value, the more significant the deterioration in quality of the resulting image is. This tendency is particularly prominent in a case where the signal amount of a RAW image itself is small, such as image capturing in the nighttime.

### SUMMARY OF THE INVENTION

The present invention provides a technique for acquiring a captured image suited to a user preference for image processing.

According to the first aspect of the present disclosure, there is provided an information processing apparatus comprising: an obtaining unit configured to obtain a recommended image-capturing parameter, based on content of image processing performed on image-capturing information obtained through image capturing; and a registration unit configured to register the image-capturing information and the recommended image-capturing parameter in association with each other as learning data.

According to the second aspect of the present disclosure, there is provided an information processing method performed by an information processing apparatus, the information processing method comprising: obtaining a recommended image-capturing parameter, based on content of image processing performed on image-capturing information obtained through image capturing; and registering the image-capturing information and the recommended image-capturing parameter in association with each other as learning data.

According to the third aspect of the present disclosure, there is provided a non-transitory computer-readable storage medium having stored therein a computer program for causing a computer to function as: an obtaining unit configured to obtain a recommended image-capturing parameter, based on content of image processing performed on image-capturing information obtained through image capturing; and a registration unit configured to register the image-capturing information and the recommended image-capturing parameter in association with each other as learning data.

Further features of the present invention will become apparent from the following description of exemplary embodiments with reference to the attached drawings.

### BRIEF DESCRIPTION OF THE DRAWINGS

FIG. 1 is a diagram showing an exemplary configuration of a system.

FIG. 2 is a block diagram showing an exemplary configuration of hardware that can be applied to a digital camera 102, a client terminal 103, an accumulation server 104, and a learning server 105.

FIG. 3 is a block diagram showing an exemplary functional configuration of each of the digital camera 102, the client terminal 103, the accumulation server 104, and the learning server 105.

FIG. 4 is a flowchart of processing performed by the system to generate learning data.

FIG. 5 is a block diagram showing an exemplary functional configuration of a learning unit 316

FIG. 6 is a flowchart of an image-capturing operation performed by the digital camera 102.

FIG. 7 is a flowchart of a series of processing for performing image editing on an image captured in an aperture priority mode, and generating learning data.

FIG. 8A is a diagram showing an exemplary display of a GUI.

FIG. 8B is a diagram showing an exemplary display of a GUI.

FIG. 9 is a flowchart of processing performed by the system to generate learning data.

FIG. 10 is a flowchart of an image-capturing operation performed by the digital camera 102.

FIG. 11 is a diagram showing an exemplary display of a recipe screen.

FIG. 12 is a flowchart of processing performed by the client terminal 103 to cause a display unit 250 to display the recipe screen.

FIG. 13 is a block diagram showing an exemplary functional configuration of the system.

FIG. 14 is a flowchart of processing performed by the system to generate learning data.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

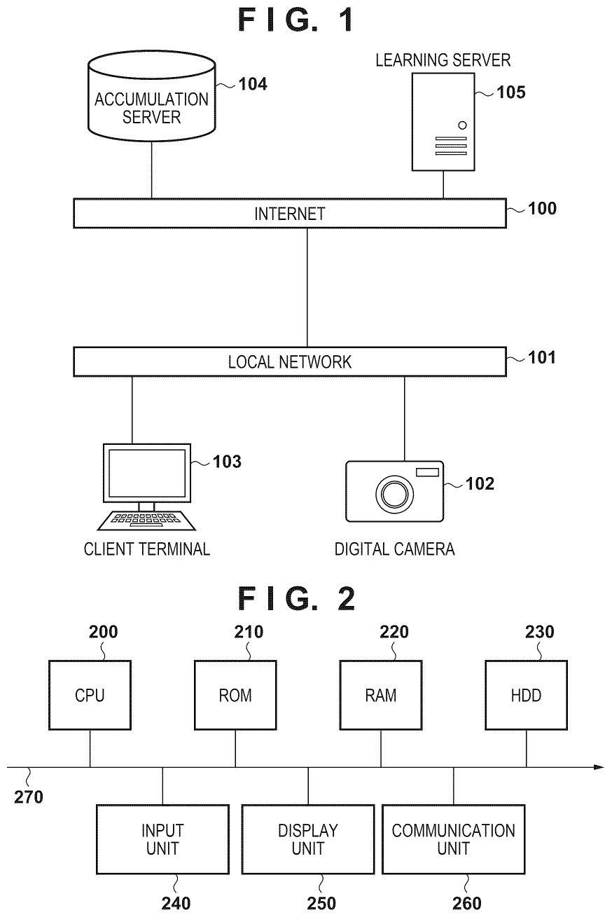

First, an exemplary configuration of a system according to the present embodiment will be described with reference to FIG. 1. A digital camera 102 and a client terminal 103 are connected to a local network 101 such as a LAN, and the local network 101 is connected to the Internet 100. An accumulation server 104 and a learning server 105 are connected to the Internet 100. The digital camera 102 is an example of an image capturing apparatus capable of capturing moving images and still images.

The client terminal 103 is a computer apparatus such as a PC, a smartphone, or a tablet terminal, and performs image processing (image manipulation/image editing) on a RAW image captured by the digital camera 102 in accordance with a user operation. Also, the client terminal 103 generates a data set obtained through the image processing, and transmits (uploads) the data set to the accumulation server 104. From the data set transmitted from the client terminal 103, the accumulation server 104 generates learning data used for supervised learning, and holds the generated learning data.

The learning server 105 executes learning of an inference model used in the digital camera 102 in response to an instruction from the user, and tests the inference model obtained by the learning and creates a report thereof. Also, the learning server 105 deploys the learned inference model to the digital camera 102 via the Internet 100 and the local network 101. Note that if the digital camera 102 cannot be connected to the Internet 100, it is also possible to download the learned inference model may be onto the client terminal 103, and deploy the learned inference model to the digital camera 102 via a portable medium such as a memory card.

Next, an exemplary configuration of hardware that can be applied to the digital camera 102, the client terminal 103, the accumulation server 104, and the learning server 105 will be described with reference to the block diagram of FIG. 2. In the case of applying the hardware configuration shown in FIG. 2 to the digital camera 102, the hardware configuration represents a hardware configuration of a calculation unit that handles images obtained by, for example, an optical system, an imaging element, or an image processing circuit.

A CPU 200 performs various types of processing using a computer program and data stored in a RAM 220. Thus, the CPU 200 performs overall operation control of an apparatus (application apparatus) to which the hardware configuration of FIG. 2 is applied, and performs or controls various types of processing described as processing performed by the application apparatus.

AROM 210 stores, for example, setting data of the application apparatus, a computer program and data relating to startup of the application apparatus, and a computer program and data relating to basic operations of the application apparatus.

The RAM 220 has an area for storing a computer program and data loaded from the ROM 210 and an HDD 230, and an area for storing a computer program and data received from an external apparatus by a communication unit 260. The RAM 220 further has a work area used by the CPU 200 when performing various types of processing. In this manner, the RAM 220 can provide various areas as appropriate.

For example, an OS, and a computer program and data for causing the CPU 200 to perform or control various types of processing described as processing performed by the application apparatus are saved in the HDD 230.

As an apparatus that plays a similar role, an external storage apparatus may be used. Here, the external storage apparatus can be implemented by, for example, a medium (recording medium) and an external storage drive for achieving access to the medium. As such a medium, a flexible disk (FD), a CD-ROM, a DVD, a USB memory, an MO, and a flash memory, for example, are known. The external storage apparatus may be a server apparatus or the like that is connected via a network.

An input unit 240 is a user interface such as a keyboard, a mouse, a touch panel, a button, or a lever, and allows the user to input various instructions and information to the application apparatus by being operated by the user.

A display unit 250 includes, for example, a liquid crystal screen or a touch panel screen, and is capable of displaying the results of processing performed by the CPU 200 using images, characters, and the like. Note that the display unit 250 may be a projection device such as a projector that projects images and characters.

The communication unit 260 performs various types of processing for performing data communication with an external apparatus. The CPU 200, the ROM 210, the RAM 220, the HDD 230, the input unit 240, the display unit 250, and the communication unit 260 are all connected to a system bus 270.

In the present embodiment, the digital camera 102 (calculation unit), the client terminal 103, the accumulation server 104, and the learning server 105 are all described as having a hardware configuration shown in FIG. 2; however, the present disclosure is not limited thereto.

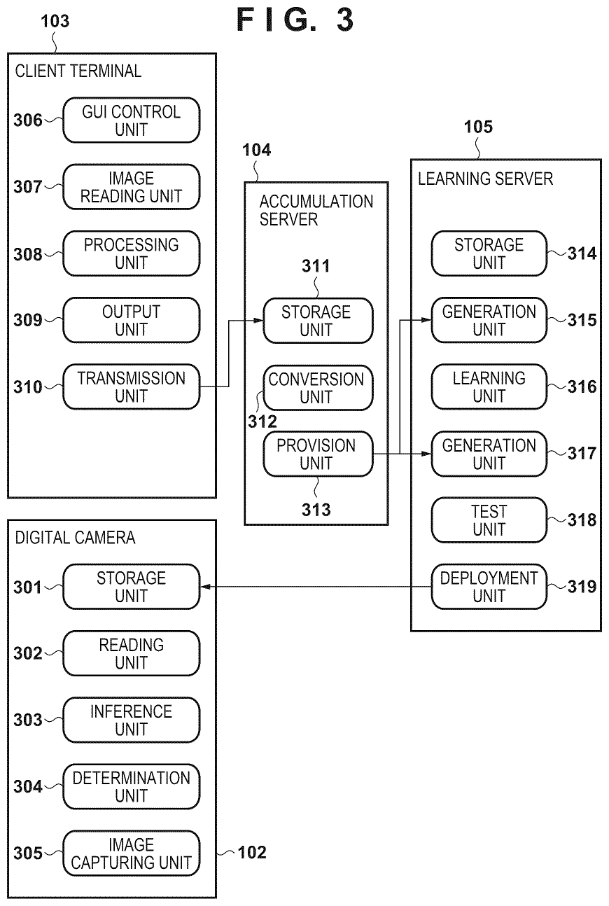

Next, the exemplary functional configuration of each of the digital camera 102, the client terminal 103, the accumulation server 104, and the learning server 105 will be described with reference to the block diagram of FIG. 3. In the present embodiment, the functional units (except for storage units 301, 311, and 314) shown in FIG. 3 are assumed to be implemented by computer programs. In the following description, the functional units (except for the storage units 301, 311, and 314) shown in FIG. 3 are described as being the executors of processing. However, actually, the functions of the functional units are realized by the CPU 200 executing computer programs corresponding to the functional units. Note that one or more of the functional units shown in FIG. 3 may be implemented by hardware.

First, the digital camera 102 will be described. The storage unit 301 stores an execution program of firmware of the digital camera 102, an image-capturing setting, a user custom setting, a learned inference model, and so forth. The storage unit 301 can be implemented using the ROM 210, the RAM 220, the HDD 230, or the like.

A reading unit 302 reads out the inference model stored in the storage unit 301, and loads the read inference model into the RAM 220. Using the inference model loaded into the RAM 220 by the reading unit 302, an inference unit 303 infers, from a live-view image (reduced developed image) captured by the digital camera 102, an image-capturing parameter serving as a correction value of a parameter such as an exposure, an ISO sensitivity, and a shutter speed. The image-capturing parameter also includes a qualitative parameter such as whether to perform HDR image capturing.

A determination unit 304 determines a parameter used for actual image capturing, based on the image-capturing parameter inferred by the inference unit 303. In response to a shutter button (not shown) being depressed by the user, an image capturing unit 305 performs an image-capturing operation based on the parameter determined by the determination unit 304, thereby obtaining a RAW image. Then, the image capturing unit 305 adds, to the RAW image, well-known Exif information including various types of information relating to the image-capturing operation (the shutter speed, the aperture (F value), the ISO sensitivity, etc. in the image-capturing operation), and saves, in the storage unit 301, the RAW image to which the Exif information has been added.

Next, the client terminal 103 will be described. The client terminal 103 obtains a RAW image captured by the digital camera 102, and performs image processing on the RAW image in accordance with a user operation.

A graphical user interface (GUI) control unit 306 causes the display unit 250 to display a GUI of software for performing, on the RAW image, image processing with image processing content in accordance with a user operation, and controls display of the GUI. The GUI control unit 306 is capable of, for example, displaying a list of image editing parameters, displaying an editing result that is output in accordance with a parameter change, and displaying comparison between images before and after editing.

In response to a user operation, an image reading unit 307 reads out, from among a group of RAW images that have been received from the digital camera 102 and saved in the HDD 230, a RAW image to be subjected to image processing, from the HDD 230 into the RAM 220.

A processing unit 308 performs, on the RAW image read out to the RAM 220 by the image reading unit 307, image processing (adjustment of the brightness, the white balance, or the like) in accordance with a user operation performed on the GUI, and outputs, to the GUI control unit 306, a captured image resulting from developing the RAW image that has been subjected to image processing. This enables the GUI control unit 306 to cause the GUI to display the captured image resulting from developing the RAW image that has been subjected to the image processing performed by the processing unit 308.

An output unit 309 performs various types of image processing including development processing on the RAW image that has been subjected to the image processing performed by the processing unit 308, thereby generating a captured image. A transmission unit 310 generates a data set including “a thumbnail image (reduced image developed at the time point of the image capturing) of a RAW image read out to the RAM 220 by the image reading unit 307”, “the captured image that has been subjected to development processing by the processing unit 308”, and “the image processing content”. Then, the transmission unit 310 transmits (uploads) the generated data set to the accumulation server 104.

Next, the accumulation server 104 will be described. The accumulation server 104 functions as an information processing apparatus that obtains a recommended image-capturing parameter, based on the content of the image processing performed on image-capturing information obtained through image capturing, and that registers the image-capturing information and the recommended image-capturing parameter in association with each other as learning data.

A storage unit 311 stores the data set uploaded from the client terminal 103. The storage unit 311 can be implemented using the ROM 210, the RAM 220, the HDD 230, or the like.

A conversion unit 312 obtains an image-capturing parameter that is recommended (recommended image-capturing parameter) from the Exif information included in the data set stored in the storage unit 311, and the image processing content included in the data set. The recommended image-capturing parameter includes one or more of a correction value of an ISO sensitivity, a correction value of an aperture value, and a correction value of a shutter speed, for example. Then, the conversion unit 312 generates learning data including the data set and the recommended image-capturing parameter, and stores the generated learning data in the storage unit 311. In response to an instruction from the learning server 105, a provision unit 313 transmits part or the whole of the learning data stored in the storage unit 311 to the learning server 105.

Next, the learning server 105 will be described. The learning server 105 is capable of, for example, learning an inference model used by the inference unit 303 for inferencing the image-capturing parameter, testing the inference model, and deploying the inference model to the digital camera 102.

A storage unit 314 stores, for each learning project, a definition file of an inference model, a progress management of a learning project, the data used for learning and testing, hyperparameters set for learning, and a learned inference mode, for example.

A generation unit 315 performs adjustment of the frequency of appearance of each piece of learning data transmitted from the provision unit 313, and pre-processing for inputting the learning data to the inference model. A generation unit 317 does not perform adjustment of the frequency of appearance of each piece of learning data transmitted from the provision unit 313, but performs pre-processing for inputting the learning data to an inference model. For example, the generation unit 317 generates test data from the learning data transmitted from the provision unit 313. The method for generating the test data from the learning data is not limited to a specific method, and the test data may be generated by manipulating part or the whole of the learning data. The test data may be generated without using the learning data.

The learning unit 316 learns an inference model using the learning data. For example, the learning unit 316 obtains “an inferred image-capturing parameter” that is an image-capturing parameter inferred with an inference model to which “a thumbnail image of the RAW image” included in the learning data has been input, by performing calculation processing of the inference model. Then, the learning unit 316 calculates an error between the recommended image-capturing parameter included in the learning data and the obtained inferred image-capturing parameter, and updates a parameter (weight or the like) of the inference model such that the error becomes smaller, thereby learning the inference model.

A test unit 318 infers the inference model that has been learned by the learning unit 316, using the test data generated by the generation unit 317, calculates a recall ratio or a relevance ratio based on a predetermined test condition, and outputs the performance of the inference model obtained by the present project.

For example, the test unit 318 obtains “an inferred image-capturing parameter” that is an image-capturing parameter inferred (subjected to test inference) with an inference model to which “a thumbnail image of the RAW image” included in the test data, by performing calculation processing of the inference model. Then, the learning unit 316 uses the obtained inferred image-capturing parameter to calculate a recall ratio or a relevance ratio based on a predetermined test condition, and outputs “the performance of the inference model obtained by the present project” based on the calculated result. The method for obtaining “the performance of the inference model” from the inferred image-capturing parameter inferred with the inference model is not limited to a specific method, and “the performance of the inference model” may be obtained through processing performed by the test unit 318 alone, or “the performance of the inference model” may be obtained via checking by a user. The output destination and the output form of “the performance of the inference model” are not limited to a specific output destination and a specific output form. For example, the test unit 318 may cause the display unit 250 to display characters and graphs representing “the performance of the inference model” as text and an image. For example, a message describing characters and graphs representing “the performance of the inference model” may be transmitted to the client terminal 103 via the communication unit 260.

A deployment unit 319 transmits, to the digital camera 102, the inference model authenticated by the user via the test inference as an inference model that may be deployed to the digital camera 102, in the form of binary information that can be used by the digital camera 102. For example, if the user determines, as a result of checking the test inference, that the learned inference model may be deployed to the digital camera 102, the user operates the input unit 240 to input a deployment instruction. Upon receiving the instruction, the deployment unit 319 transmits, to the digital camera 102, the learned inference model in the form of binary information that can be used by the digital camera 102. The information is stored (downloaded) in the storage unit 301 of the digital camera 102 via the Internet 100 and the local network 101.

In the following, it is assumed that the user has operated the client terminal 103 to perform an adjustment operation for adjusting the brightness of a RAW image as image processing on the RAW image. In this case, the learning server 105 learns an inference model for inferring an exposure correction value corresponding to the input thumbnail image of the RAW image, and the digital camera 102 uses the inference model to infer an exposure correction value corresponding to the captured RAW image.

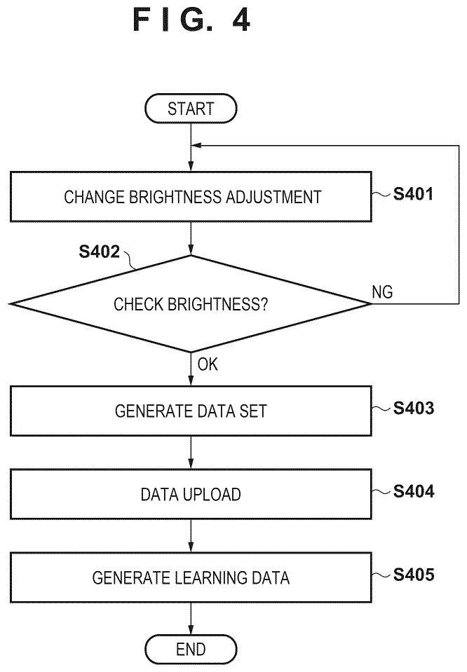

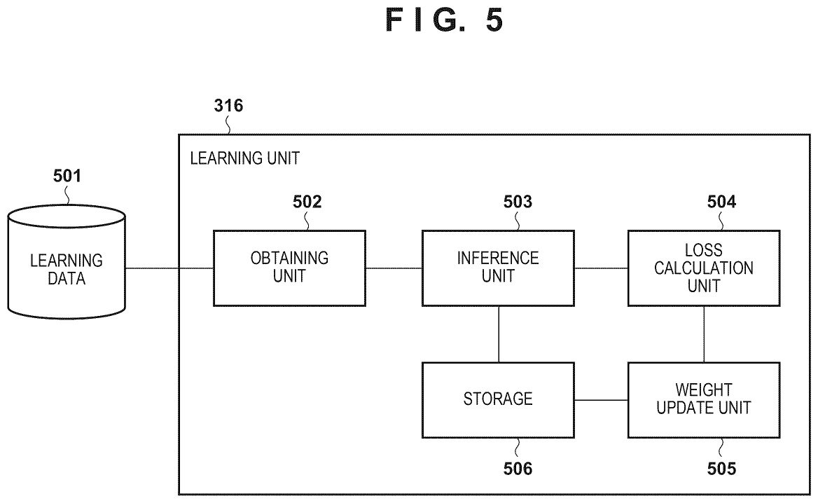

Next, processing performed by the system according to the present embodiment to generate learning data will be described with reference to the flowchart of FIG. 4. When a user of the client terminal 103 operates the input unit 240 to input an instruction to activate image editing software, the GUI control unit 306 causes the display unit 250 to display a GUI of the image editing software. The output unit 309 generates a captured image by performing various types of image processing including development processing on the RAW image that has been read out from the HDD 230 to the RAM 220 by the image reading unit 307. Then, the GUI control unit 306 causes the GUI to display the captured image developed by the output unit 309. Then, when the user operates the input unit 240 to input an operation instruction for adjusting the brightness, the processing unit 308, in step S401, performs brightness adjustment on the RAW image in accordance with the operation instruction, and the output unit 309 generates a captured image resulting from developing the RAW image to which a brightness adjustment value has been added, and outputs the captured image to the GUI control unit 306. This enables the GUI control unit 306 to cause the GUI to display the captured image.

Then, the user checks the captured image displayed in the GUI to determine whether the captured image has been adjusted to a desired brightness. Then, if the user determines that the captured image displayed in the GUI has been adjusted to the desired brightness, and operates the input unit 240 to input an instruction indicating to that effect, the processing proceeds to step S403 via step S402. On the other hand, if such an instruction has not been input, the processing proceeds to step S401 via step S402.

In step S403, the output unit 309 generate a data set including “a thumbnail image of the RAW image read out to the RAM 220 by the image reading unit 307, “a captured image that has been subjected to development processing in accordance with the brightness adjustment value”, and “the content of the brightness adjustment”. The thumbnail image of the RAW image is a reduced pre-edit image for use in GUI display that was developed with a setting at the time of the image capturing.

In step S404, the transmission unit 310 transmits (uploads) the data set generated in step S403 to the accumulation server 104. These images may include an image that has not been edited as a consequence.

In step S405, the conversion unit 312 stores the data set uploaded from the client terminal 103 in the storage unit 311. Then, the conversion unit 312 obtains a recommended exposure correction value as a recommended image-capturing parameter from the Exif information included in the data set stored in the storage unit 311, and the content of brightness adjustment (brightness adjustment value) included in the data set.

Here, if the parameter for adjusting the brightness is the gain amount of digital gains as it is, the brightness adjustment value is directly used as the recommended exposure correction value. The recommended exposure correction value is ground truth (GT) data in the present embodiment, and can be considered as an exposure correction value with which a captured image captured with an exposure determined automatically or manually by a user should have been corrected in order for the user to achieve the exposure that he or she considers appropriate.

Then, the conversion unit 312 generates learning data including data set and a recommended exposure correction value obtained using the data set, and stores the generated learning data in the storage unit 311. Here, an exemplary functional configuration of the learning unit 316 will be described with reference to the block diagram of FIG. 5. An obtaining unit 502 obtains learning data 501. An inference unit 503 obtains an exposure correction value that is an image-capturing parameter inferred with an inference model to which “the thumbnail image of the RAW image” included in the learning data 501 obtained by the obtaining unit 502, by performing calculation processing of the inference model.

A loss calculation unit 504 calculates an error (loss) between the recommended exposure correction value included in the learning data 501, and the exposure correction value obtained by the inference unit 503. As a loss function serving as a function for calculating the error (loss), an L1 loss commonly used for a regression task is used.

A weight update unit 505 updates the current “weight serving as a parameter of the inference model” stored in the current storage 506 such that the error (loss) calculated by the loss calculation unit 504 becomes smaller, thereby learning the inference model.

In the present embodiment, it is assumed that the inference model having, as a parameter, the weight stored in the storage 506 at the time of ending of the learning is output to a recording medium (an SD card or the like) of the digital camera 102 by the deployment unit 319. However, the output destination of the inference model is not limited to the digital camera 102, and may be, for example, a memory of a general-purpose computer or a control circuit in a camera.

As the above-described inference model, it is possible to apply various models, including, for example, support vector machines (SVMs) combined with a neural network such as a convolutional neural network (CNN), vision transformer (ViT), or a feature extractor.

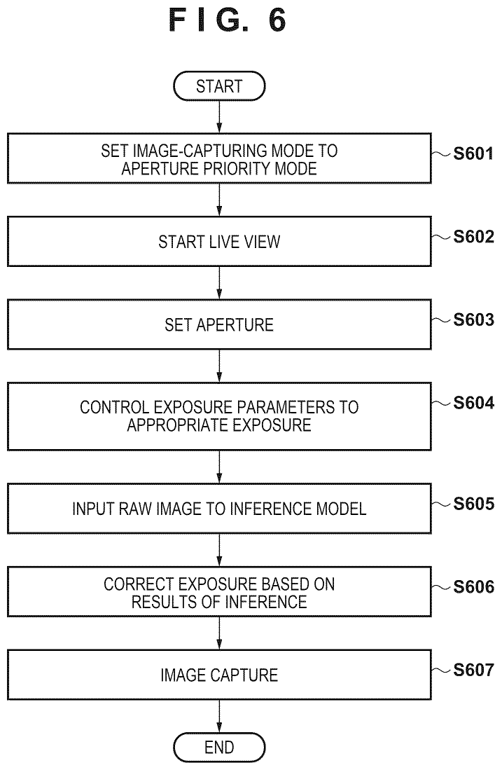

Next, the image-capturing operation performed by the digital camera 102 will be described with reference to the flowchart of FIG. 6. In step S601, the image capturing unit 305 sets the image-capturing mode to an aperture priority mode in accordance with a mode switching instruction input by the user operating the input unit 240. In step S602, the image capturing unit 305 starts live view, and causes an imaging element to be constantly exposed to light.

In step S603, the image capturing unit 305 sets an aperture value input by the user operating the input unit 240. In step S604, based on the aperture value set in step S603, the image capturing unit 305 adjusts exposure parameters other than the aperture, namely, the ISO sensitivity and the shutter speed so as to achieve an appropriate exposure.

In step S605, the inference unit 303 inputs, to the inference model loaded into the RAM 220 by the reading unit 302, intermediate images resulting from developing RAW images sequentially output from the image capturing unit 305 by the live view performed by the image capturing unit 305.

In step S606, the inference unit 303 infers an image-capturing parameter by performing calculation processing on the inference model. Based on the image-capturing parameter inferred by the inference unit 303, the determination unit 304 determines a parameter to be used for the actual image capturing. Then, the image capturing unit 305 performs exposure correction in accordance with the determined parameter. Then, the image capturing unit 305 obtains a RAW image by performing the image-capturing operation in response to a shutter button (not shown) being depressed by the user.

### Modification 1

In exposure correction of the digital camera 102, in general, an exposure parameter is definitely determined along a diagram such as a program diagram. However, some users may wish to perform exposure correction using a combination of other exposure parameters.

Accordingly, in the present modification, the user is provided with a GUI that allows an exposure parameter to be moved in a pseudo manner, and an inference model for inferring the exposure parameter is generated from GT data generated with the GUI.

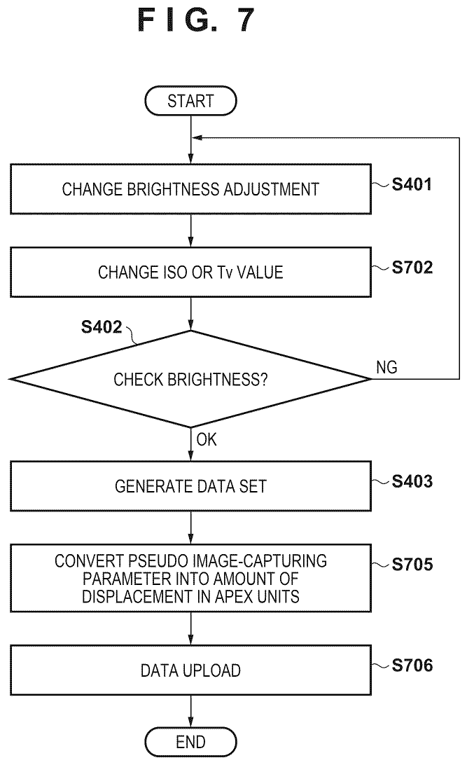

A series of processing for performing image editing on an image captured in the aperture priority mode, and generating learning data will be described with reference to the flowchart of FIG. 7. In FIG. 7, processing steps that are the same as the processing steps shown in FIG. 4 are denoted by the same step numbers as the corresponding processing steps, and descriptions of the processing steps have been omitted.

The user operates the input unit 240 to change the ISO sensitivity and the Tv value, and selects a combination of an ISO sensitivity and a Tv value that achieves the brightness adjustment performed in step S401. Accordingly, in step S702, the processing unit 308 obtains the selected combination.

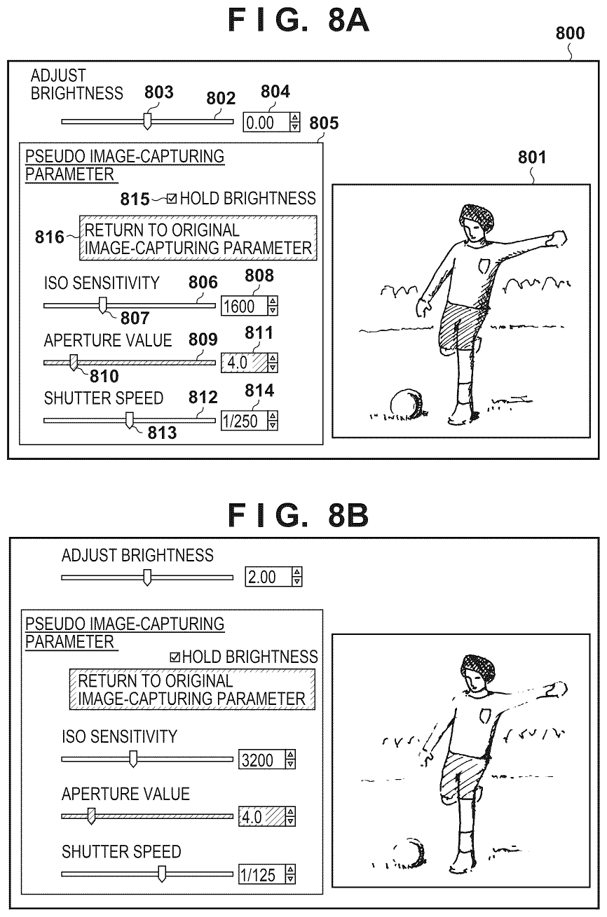

FIG. 8A shows an exemplary display of a GUI according to the present embodiment. In a GUI 800, a captured image being edited is displayed in a display region 801. A slider 802 is a slider for performing brightness adjustment. When the user operates the input unit 240 to move a knob 803 laterally, the brightness of the captured image displayed in the display region 801 is adjusted in accordance with a brightness adjustment value corresponding to the position of the knob 803. That is, a preview of a captured image that has been subjected to development processing in accordance with the brightness adjustment value currently set by the user is presented to the user. In addition, the brightness adjustment value corresponding to the position of the knob 803 is displayed in a numerical value window 804 equipped with a spin button. Note that the brightness adjustment value can also be adjusted using the spin button.

A region 805 is a region in which an operation unit for varying a pseudo image-capturing parameter in accordance with the brightness adjustment. A slider 806 is a slider for performing ISO sensitivity adjustment. When the user operates the input unit 240 to move a knob 807 laterally, the ISO sensitivity is updated to an ISO sensitivity corresponding to the position of the knob 807. The ISO sensitivity corresponding to the position of the knob 807 is displayed in a numerical value window 808 equipped with a spin button. Note that the ISO sensitivity can also be adjusted using the spin button.

A slider 809 is a slider for performing aperture value adjustment. When the user operates the input unit 240 to move the knob 810 laterally, the aperture value is updated to an aperture value corresponding to the position of the knob 810. The aperture value corresponding to the position of the knob 810 is displayed in a numerical value window 811 equipped with a spin button. Note that the aperture value can also be adjusted using the spin button.

A slider 812 is a slider for performing shutter speed adjustment. When the user operates the input unit 240 to move the knob 813 laterally, the shutter speed is updated to a shutter speed corresponding to the position of the knob 813. The shutter speed corresponding to the position of the knob 813 is displayed in a numerical value window 814 equipped with a spin button. Note that the shutter speed can also be adjusted using the spin button.

Note that the values of the ISO sensitivity and the shutter speed change in conjunction with the brightness adjustment value. Since the captured image is an image captured in the aperture priority mode, the operation units (the slider 809, the knob 810, and the numerical value window 811 equipped with a spin button) relating to the aperture value are in a disabled state in FIG. 8A.

A checkbox 815 is used for determining, when the pseudo image-capturing parameter has been changed, whether the brightness adjustment is to be changed accordingly. When the user operates the input unit 240 to check the checkbox 815, the value of the shutter speed, in response to the ISO sensitivity being changed, changes so as to cancel out the amount of change in the ISO sensitivity. For example, when the ISO sensitivity is moved from 1600 to 3200 in FIG. 8A, the shutter speed is changed from 1/250 to 1/500, and the EV value is kept constant. On the other hand, when the user operates the input unit 240 to uncheck the checkbox 815, the ISO sensitivity and the shutter speed can be freely changed, and a brightness adjustment value corresponding to the changed exposure is reflected in the position of the knob 803, the numerical value window 804 equipped with a spin button, and the display region 801. When the user operates the input unit 240 to indicate a button 816, the image-capturing parameter is returned to the original image-capturing parameter (the brightness adjustment value is an origin (0.00)).

The ISO sensitivity and the shutter speed that can be set in the GUI 800 of FIG. 8A are merely pseudo parameters, and it is, of course, not possible to create a captured image for which these parameters have been changed after capturing. However, the ISO sensitivity and the shutter speed that realize exposure correction that the user wished to capture can be recorded by the user.

In step S705, the transmission unit 310 converts the pseudo image-capturing parameter into an amount of displacement from the original image-capturing parameter in Additive System of Photographic Exposure (APEX) units. A specific method for converting the pseudo image-capturing parameter in the present modification will be described with reference to FIG. 8B.

FIG. 8B indicates a screen of the GUI 800 in a state in which the brightness adjustment has been changed to +2.00. To realize the brightness adjustment +2.00, the ISO sensitivity and the shutter speed in the pseudo image-capturing parameter are each adjusted in a direction in which the exposure is overexposed by one step from FIG. 8A. In this case, the amount of displacement of the ISO sensitivity in APEX units is +1.00 (EV), and the amount of displacement of the shutter speed in APEX units is also +1.00 (EV), and this value is used as a pseudo image-capturing parameter (GT data)

In step S706, the transmission unit 310 stores, in the data set generated in step S403, the pseudo image-capturing parameter converted in step S705, and transmits (uploads) the data set in which the pseudo image-capturing parameter is stored to the accumulation server 104.

In the present modification as well, the configuration of the learning unit 316 is the same as that of FIG. 5. However, the learning data 501 includes the data set and the pseudo image-capturing parameter, and the inference unit 503 learns an inference model using the pseudo image-capturing parameter as the GT data, thereby inferring the amount of displacement of the exposure parameter relative to the RAW image.

While the image-capturing operation performed by the digital camera 102 is basically processing in accordance with the flowchart of FIG. 6, the results of the inference in step S606 are the amount of displacement of the ISO sensitivity and the Tv value. Therefore, the actual ISO sensitivity and the actual Tv value are changed in accordance with therewith.

### Modification 2

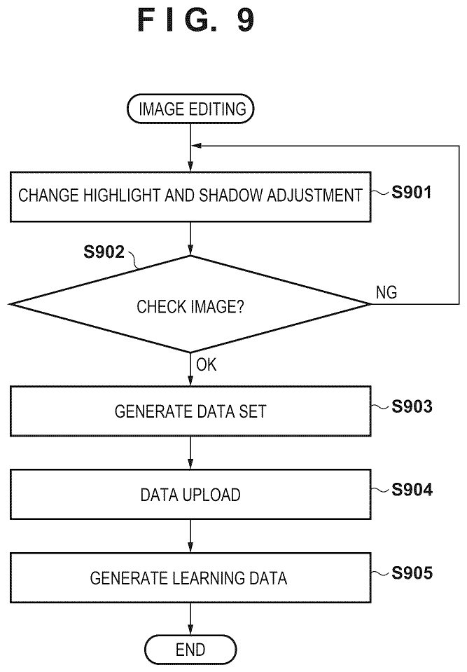

In the present modification, for image processing for adjusting the dynamic range, an HDR image capturing recommendation flag indicating whether to perform HDR image capturing is stored in a data set as GT data, and an inference model for inferring whether to perform HDR image capturing is learned using the HDR image capturing recommendation flag as the GT data. Processing performed by a system according to the present embodiment to generate learning data will be described with reference to the flowchart of FIG. 9.

When a user of the client terminal 103 operates the input unit 240 to input an instruction to activate image editing software, the GUI control unit 306 causes the display unit 250 to display a GUI of the image editing software. The output unit 309 performs various types of image processing, including development processing, on a RAW image read out from the HDD 230 to the RAM 220 by the image reading unit 307, thereby generating a captured image. Then, the GUI control unit 306 causes the GUI to display the captured image developed by the output unit 309. When the user operates the input unit 240 to input an operation instruction for adjusting highlight and shadow, the processing unit 308, in step S901, performs highlight and shadow adjustment in accordance with the operation instruction on the RAW image, and the output unit 309 generates a captured image resulting from developing the RAW image in accordance with the highlight and shadow adjustment value, and outputs the captured image to the GUI control unit 306. This enables the GUI control unit 306 to cause the GUI to display the captured image.

The user checks the captured image displayed in the GUI to check for whiteout, blackout, and the like, and determines whether the captured image has been adjusted to a desired gradation expression. If the user determines that the captured image displayed in the GUI has been adjusted to the desired gradation expression, and operates the input unit 240 to input an instruction indicating to that effect, the processing proceeds to step S903 via step S902. On the other hand, if such an instruction has not been input, the processing proceeds to step S901 via step S902.

In step S903, the transmission unit 310 generates a data set including “a thumbnail image (reduced pre-edit image) of the RAW image read out to the RAM 220 by the image reading unit 307”, “the captured image that has been subjected to development processing in accordance with the highlight and shadow adjustment value”, and “the content of the highlight and shadow adjustment”.

In step S904, the transmission unit 310 transmits (uploads) the data set generated in step S903 to the accumulation server 104. These images may include an image that has not been edited as a consequence

In step S905, the conversion unit 312 stores the data set uploaded from the client terminal 103 in the storage unit 311. Then, the conversion unit 312 obtains an HDR image capturing recommendation flag as a recommended image-capturing parameter from the content (highlight and shadow adjustment values) of the highlight and shadow adjustment that is included in the data set stored in the storage unit 311. The highlight and shadow adjustment value includes a highlight adjustment value and a shadow adjustment value.

Here, the value of the HDR image capturing recommendation flag is set to 1 if a value resulting from subtracting a highlight adjustment amount from a shadow adjustment amount is greater than or equal to a threshold, and is set to 0 if the value is less than the threshold. Doing so enables a flag for recommending HDR image capturing to be added to an image that has been subjected to editing by which the dynamic range is compressed such that the value is greater than or equal to the threshold.

Thus, the learning data according to the present embodiment includes the data set and the HDR image capturing recommendation flag. The learning unit 316 according to the present modification has the exemplary functional configuration shown in FIG. 5 as in the case of the Modification 1 of the first embodiment, but differs from Modification 1 of the first embodiment in the following points.

The obtaining unit 502 obtains the learning data 501. The inference unit 503 obtains “an HDR image capturing recommendation value indicating whether to perform HDR image capturing for an input image” that is an image-capturing parameter inferred with an inference model to which “a thumbnail image of the RAW image” included in the learning data 501 obtained by the obtaining unit 502, by performing calculation processing of the inference model. The HDR image capturing recommendation value is a scalar value and has a value range of [0, 1].

The loss calculation unit 504 calculates an error (loss) between the HDR image capturing recommendation flag included in the learning data 501, and the HDR image capturing recommendation value obtained by the inference unit 503. Since the present task is binary classification, binary cross-entropy is used as a loss function serving as the function for calculating the error (loss).

The weight update unit 505 updates the current “weight serving as a parameter of the inference model” stored in the current storage 506 such that the error (loss) calculated by the loss calculation unit 504 becomes smaller, thereby learning the inference model.

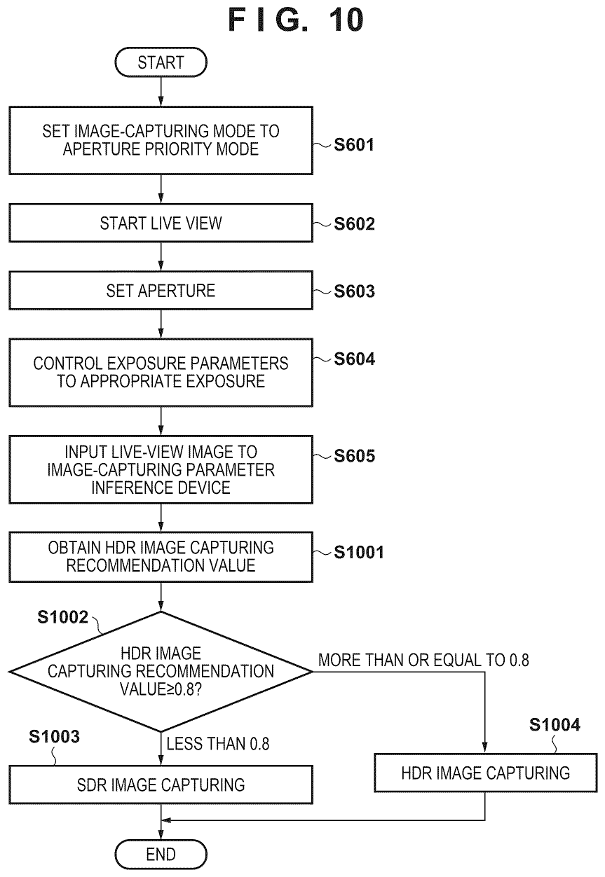

Next, the image-capturing operation performed by the digital camera 102 will be described with reference to the flowchart of FIG. 10. In the flowchart of FIG. 10, processing steps that are the same as the processing steps shown in FIG. 6 are denoted by the same step numbers as the step numbers of the corresponding processing steps, and descriptions of the processing steps have been omitted.

In step S1001, the inference unit 303 obtains an HDR image capturing recommendation value by performing calculation processing of the inference model. Then, in step S1002, the inference unit 303 determines whether the HDR image capturing recommendation value obtained in step S1001 is 0.8 or more.

As a result of this determination, if the HDR image capturing recommendation value is 0.8 or more, the processing proceeds to step S1004. If the HDR image capturing recommendation value is less than 0.8, the processing proceeds to step S1003. In step S1003, the image capturing unit 305 performs normal image capturing, or in other words, SDR image capturing, and in step S1004, the image capturing unit 305 performs HDR image capturing.

### Modification 3

In the present modification, an image-capturing recipe is output using a learned inference model. An image-capturing recipe refers to information relating to image capturing for capturing a given image, and is information for capturing a beautiful, visually appearing image.

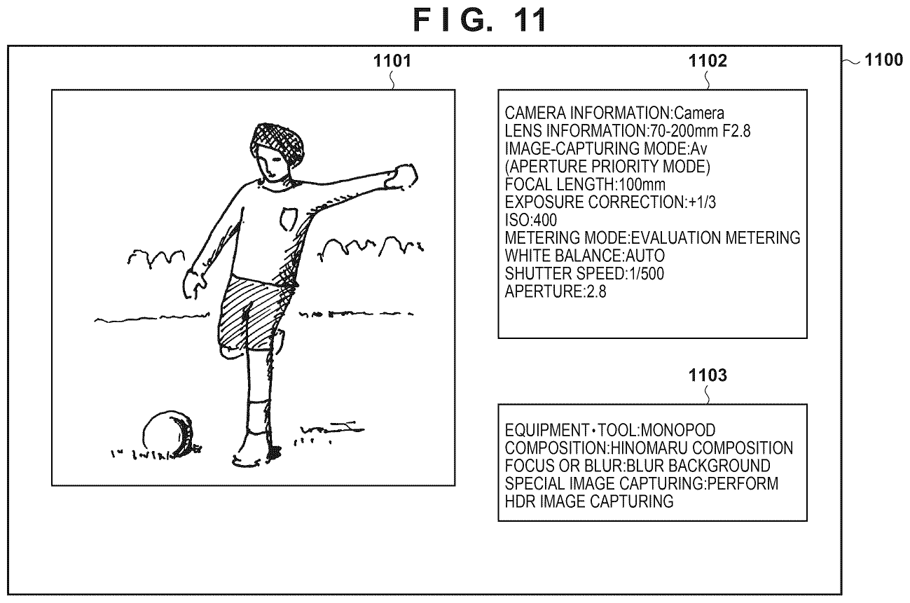

FIG. 11 shows an exemplary display of a recipe screen showing an image-capturing recipe for image capturing of a sports scene of a person. A recipe screen 1100 illustrated in FIG. 11 is displayed in the display unit 250 of the client terminal 103. However, the recipe screen 1100 may be displayed in another apparatus.

In the display region 1101, a sample image of the sports scene is displayed. The sample image may be a captured image of the sports scene captured by the image capturing unit 305, or may be a captured image of the sports scene that is saved in advance in the HDD 230. By viewing the sample image displayed in the display region 1101, a user can specifically envisage (picture) an image obtainable by performing the image capturing in accordance with the image-capturing recipe.

Image-capturing setting information 1102 includes information about the digital camera 102, such as camera information and lens information, an image-capturing mode, set values (a focal length, an exposure correction, an ISO sensitivity, a metering mode, a white balance, a shutter speed, and an aperture value) of the digital camera 102 used at the time of image capturing.

An image-capturing tip 1103 is information illustrating a tip (the equipment or tool used at the time of image capturing, the composition showing the arrangement of a subject, the focus or blur, the method of postprocessing) for capturing a better image.

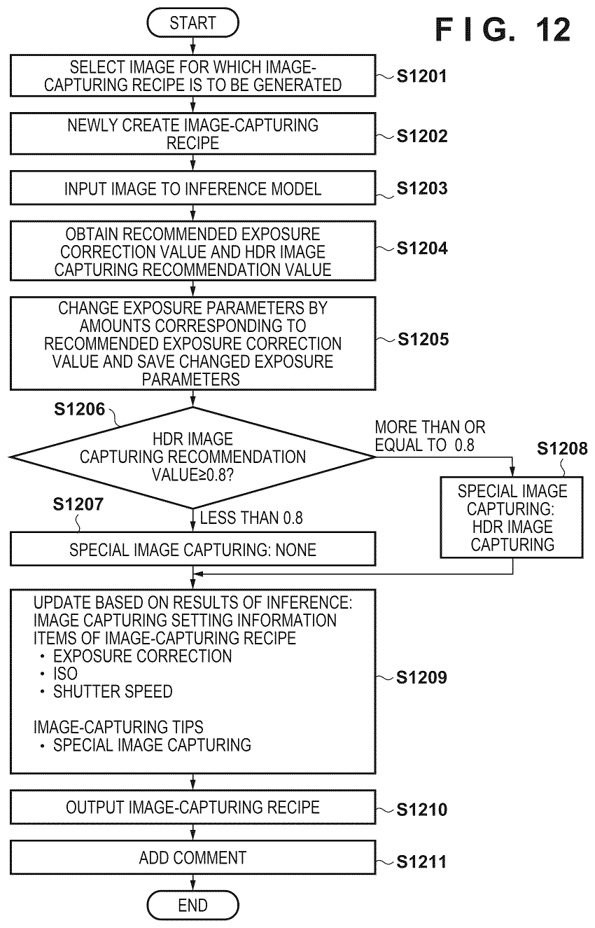

Processing performed by the client terminal 103 to cause the display unit 250 to display the above-described recipe screen will be described with reference to the flowchart of FIG. 12. After the activation of image editing software, in step S1201, the CPU 200 selects, from among RAW images that have been subjected to image processing, an image for which the image-capturing recipe is to be generated. This selection may be performed by a user through an operational input using the input unit 240, or may be performed by the CPU 200 in accordance with a predetermined criterion.

In step S1202, the CPU 200 newly creates an image-capturing recipe for the RAW image selected in step S1201. The same content as that of the Exif information is input to the image-capturing setting information (the image-capturing setting information 1102 in the example of FIG. 11) of the image-capturing recipe at this time. In addition, nothing is input to each of the items in the image-capturing tip 1103.

In step S1203, the CPU 200 inputs the RAW image selected in step S1201 to the inference model held by the digital camera 102. In step S1204, the CPU 200 obtains a recommended exposure correction value and an HDR image capturing recommendation value by causing the digital camera 102 to calculate the inference model to which the RAW image selected in step S1201 has been input.

In step S1205, the CPU 200 changes the exposure parameters (i.e., the ISO sensitivity and the Tv value) by amounts corresponding to the recommended exposure correction value obtained in step S1204, and saves the changed exposure parameters in the RAM 220.

In step S1206, the CPU 200 determines whether the HDR image capturing recommendation value obtained in step S1204 is 0.8 or more. As a result of the determination, if the HDR image capturing recommendation value is 0.8 or more, the processing proceeds to step S1208. If the HDR image capturing recommendation value is less than 0.8, the processing proceeds to step S1207.

In step S1207, the CPU 200 sets the special image capturing included in the image-capturing tip of the image-capturing recipe to “NONE”, and saves the setting in the RAM 220. On the other hand, in step S1208, the CPU 200 sets the special image capturing to “HDR image capturing”, and saves the setting in the RAM 220.

In step S1209, the CPU 200 updates the corresponding items of the image-capturing recipe with the information stored in the RAM 220 in step S1205, step S1207, step S1208, and so forth. In step S1210, the CPU 200 causes the display unit 250 to display the image-capturing recipe updated in step S1209.

In step S1211, the CPU 200 accepts addition of comments by the user for items, such as the description of composition and the focus or blur, of the image-capturing recipe that cannot be definitely determined from the camera settings and the results of inference of the image-capturing parameter.

By performing image capturing after inferring, from image editing parameters, image-capturing parameters that are to be originally set in this manner, a captured image closer to an image to which the user's preferred editing has been applied can be obtained at the time of image capturing. This can reduce not only the load of subsequent steps, but also the adjustment range for image editing, thus making it possible to reduce the acquired noise resulting from image editing.

Furthermore, for an image captured with undesirable image-capturing parameters, it is possible to infer image-capturing parameters that are to be originally set, and reflect the image-capturing parameters in the image-capturing recipe. Accordingly, it is also possible to output an image-capturing recipe conforming to the intent of the user.

Although the inference model according to the present embodiment is configured to infer the exposure parameter and the flag for performing HDR image capturing, any other image-capturing parameter that can be set both during image editing and during image capturing in the same manner can also be inferred. Specifically, the intensity of noise reduction or sharpness, and the chroma can also be inferred in the same manner.

### Second Embodiment

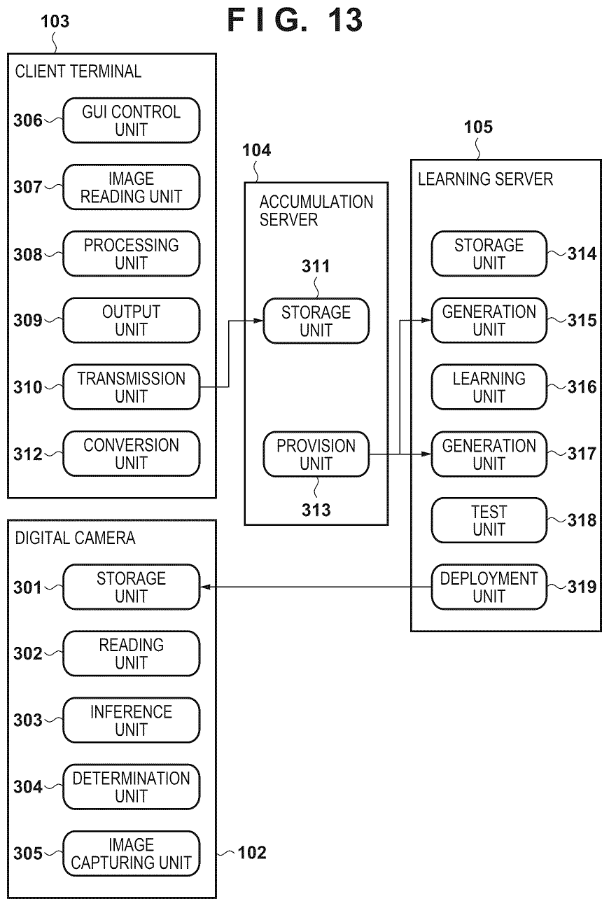

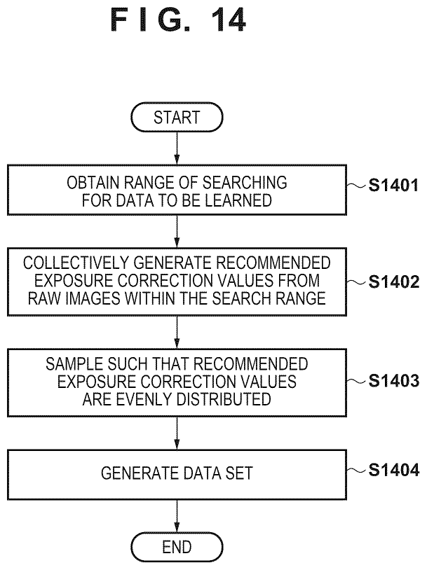

The present embodiment will be described in terms of differences from the first embodiment, and is assumed to be the same as the first embodiment unless otherwise mentioned in the following. An exemplary functional configuration of a system according to the present embodiment will be described with reference to the block diagram of FIG. 13. In FIG. 13, functional units that are the same as the functional units shown in FIG. 3 are denoted by the same reference numerals as those of the corresponding functional units, and descriptions of the functional units have been omitted. In the first embodiment, the conversion unit 312 is included in the accumulation server 104. However, in the present embodiment, the conversion unit 312 is included in the client terminal 103. Processing performed by the system according to the present embodiment to generate learning data will be described with reference to the flowchart of FIG. 14.

In step S1401, the GUI control unit 306 obtains a range (search range) of searching for data to be learned that has been input by the user operating the input unit 240. The search range is, for example, an image retrieval condition.

In step S1402, the image reading unit 307 obtains RAW images within the search range obtained in step S1401, and the conversion unit 312 collectively generates recommended exposure correction values from the obtained RAW images.

In step S1403, the transmission unit 310 samples the RAW images such that the recommended exposure correction values are evenly distributed. For example, the recommended exposure correction values are divided into seven groups: a group less than −2.5; a group greater than or equal to −2.5 and less than −1.5; a group greater than or equal to −1.5 and less than −0.5; a group greater than or equal to −0.5 and less than 0.5; a group greater than or equal to 0.5 and less than 1.5; a group greater than or equal to 1.5 and less than 2.5; and a group greater than or equal to 2.5, and the RAW images are sampled such that the numbers of RAW images respectively belonging to the groups are equal. If unedited RAW images are within the search range, the unedited RAW images are also sampled assuming that their recommended exposure correction values are 0.0.

In step S1404, the transmission unit 310 generates a data set including “thumbnail images (reduced pre-edit images) of the RAW images sampled by the image reading unit 307”, “the content of the brightness adjustment”, and “the recommended exposure correction value”. Then, the transmission unit 310 transmits (uploads) the generated data set to the accumulation server 104.

In this manner, the data set can be generated from a large amount of edited or unedited RAW images present in the client terminal 103, and therefore the accuracy of the inference model can be easily increased.

In the present embodiment, the RAW images are sampled such that objective variables to be inferred are evenly distributed. However, if a sufficient amount of RAW images cannot be obtained, sampling may be simply performed only from edited RAW images, or sampling may be performed in accordance with the period of the image processing. For example, sampling may be performed from data whose time stamp is newer than the capturing date. For example, the time spent on manipulating and editing a single image may be accumulated, and a set of image-capturing information and a recommended image-capturing parameter that have been sampled from data whose time stamp is newer than the capturing date of the image may be registered.

Each of the above embodiments has described a case where the client terminal 103, the accumulation server 104, and the learning server 105 are separate apparatuses. However, the present disclosure is not limited thereto, and two or more of these devices may be integrated into a single apparatus.

The numerical values, the processing timings, the processing orders, the executors of the processing, the configuration/obtaining methods/transmission destinations/transmission sources/storage places of data (information), and the like used in the above embodiments and modifications are used as examples in order to provide the specific description, and are not intended to be limited to such an example.

Some or all of the above-described embodiments and modifications may be used in combination as appropriate. In addition, some or all of the above-described embodiments and modifications may be selectively used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070809, filed Apr. 24, 2024, which is hereby incorporated by reference herein in its entirety.

What is claimed is:

1. An information processing apparatus comprising:
an obtaining unit configured to obtain a recommended image-capturing parameter, based on content of image processing performed on image-capturing information obtained through image capturing; and
a registration unit configured to register the image-capturing information and the recommended image-capturing parameter in association with each other as learning data.

2. The information processing apparatus according to claim 1, wherein
the image-capturing information includes a thumbnail image of a RAW image, and Exif information.

3. The information processing apparatus according to claim 2, wherein
the thumbnail image of the RAW image is a reduced image developed at a time point of the image capturing.

4. The information processing apparatus according to claim 2, wherein
the obtaining unit obtains a recommended exposure correction value from a brightness adjustment value in brightness adjustment performed on the RAW image, and the Exif information.

5. The information processing apparatus according to claim 1, wherein
the recommended image-capturing parameter includes one or more of a correction value of an ISO sensitivity, a correction value of an aperture value, and a correction value of a shutter speed.

6. The information processing apparatus according to claim 1, wherein
the obtaining unit further obtains a pseudo image-capturing parameter that includes an ISO sensitivity, an aperture value, and a shutter speed, and that is set according to brightness adjustment, and
the pseudo image-capturing parameter changes in conjunction with a brightness adjustment value in the brightness adjustment.

7. The information processing apparatus according to claim 1, wherein
the obtaining unit obtains, as a flag indicating whether to perform HDR image capturing, a flag that has 1 if a value resulting from subtracting a highlight adjustment value from a shadow adjustment value is greater than or equal to a threshold, and has 0 if the value is less than the threshold.

8. The information processing apparatus according to claim 1, further comprising:
an inference unit configured to infer an image-capturing parameter by performing calculation processing of an inference model that is based on the image-capturing information; and
a learning unit configured to learn the inference model, based on an error between the image-capturing parameter inferred by the inference unit, and the recommended image-capturing parameter.

9. The information processing apparatus according to claim 8, further comprising
a deployment unit configured to deploy the inference model that has been learned by the learning unit to an image capturing apparatus.

10. The information processing apparatus according to claim 1, further comprising
a unit configured to: infer an image-capturing parameter by performing calculation processing of an inference model to which a sample image has been input; generate a screen showing an image capturing recipe, based on the inferred image-capturing parameter; and output the screen.

11. The information processing apparatus according to claim 1, wherein
the obtaining unit obtains a recommended image-capturing parameter, based on content of image processing performed on image-capturing information within a search range, and registers the image-capturing information that has been sampled, and the recommended image-capturing parameter in association with each other.

12. The information processing apparatus according to claim 11, wherein
the image-capturing information that has been sampled is image-capturing information that has been sampled based on the recommended image-capturing parameter.

13. The information processing apparatus according to claim 11, wherein
the image-capturing information that has been sampled is image-capturing information that has been sampled based on a period of the image processing.

14. The information processing apparatus according to claim 11, wherein
the image-capturing information that has been sampled is image-capturing information that has been sampled based on a time stamp of the image-capturing information.

15. An information processing method performed by an information processing apparatus, the information processing method comprising:
obtaining a recommended image-capturing parameter, based on content of image processing performed on image-capturing information obtained through image capturing; and
registering the image-capturing information and the recommended image-capturing parameter in association with each other as learning data.

16. A non-transitory computer-readable storage medium having stored therein a computer program for causing a computer to function as:
an obtaining unit configured to obtain a recommended image-capturing parameter, based on content of image processing performed on image-capturing information obtained through image capturing; and
a registration unit configured to register the image-capturing information and the recommended image-capturing parameter in association with each other as learning data.
